(19) United States
(12) Patent Application Publication
(10) Pub. No.: US 2025/0292804 A1
(43) Pub. Date: Sep. 18, 2025

(54) ELECTRONIC DEVICE, CONTROL METHOD OF ELECTRONIC DEVICE, AND NON-TRANSITORY COMPUTER READABLE MEDIUM

(71) Applicant: CANON KABUSHIKI KAISHA, Tokyo (JP)

(72) Inventor: EMI KONDO, Tokyo (JP)

(21) Appl. No.: 19/070,885

(22) Filed: Mar. 5, 2025

(30) Foreign Application Priority Data
Mar. 12, 2024 (JP) 2024-038049

(51) Int. Cl. G11B 27/34; G06F 16/51; H04N 23/63

(52) U.S. Cl. CPC G11B 27/34; G06F 16/51; H04N 23/631

(57) ABSTRACT

An electronic device according to the present invention includes: an electronic device comprising: a processor; and a memory storing a program which, when executed by the processor, causes the electronic device to execute acquisition processing of acquiring a plurality of captured images to which file numbers are assigned according to a specific rule; execute reception processing of receiving an instruction to insert a divider image between two captured images adjacent in order of file numbers among the plurality of captured images; and execute generation processing of generating, in a case where the reception processing receives the instruction, a divider image to which a file number between file numbers of the two captured images among the file numbers is assigned, if the file numbers of the two captured images are not consecutive.

### BACKGROUND OF THE INVENTION

### Field of the Invention

The present invention relates to an electronic device, a control method of an electronic device, and a non-transitory computer readable medium.

### Description of the Related Art

There is a technique of inserting a divider image in order to enable quick recognition of a division between shot images. By treating the divider image in the same manner as a shot image, handling of the divider image is facilitated when these images are duplicated to another terminal such as a PC.

JP 2008-244778 A describes a technique of inserting a divider image when a predetermined condition is satisfied at the time of shooting. JP 2014-225083 A describes a method for assigning file numbers in shot images acquired by a plurality of cameras in such a manner that the same file number are not repetitively assigned. However, JP 2008-244778 A and JP 2014-225083 A merely describe a technique used during shooting, and do not describe a technique of inserting a divider image during playback of an image.

### SUMMARY OF THE INVENTION

The present invention provides a technique related to insertion of a divider image during playback of an image.

The present invention in one of its aspects provides an electronic device including: a processor; and a memory storing a program which, when executed by the processor, causes the electronic device to execute acquisition processing of acquiring a plurality of captured images to which file numbers are assigned according to a specific rule; execute reception processing of receiving an instruction to insert a divider image between two captured images adjacent in order of file numbers among the plurality of captured images; and execute generation processing of generating, in a case where the reception processing receives the instruction, a divider image to which a file number between file numbers of the two captured images among the file numbers is assigned, if the file numbers of the two captured images are not consecutive.

The present invention in one of its aspects provides a control method of an electronic device, including: acquiring a plurality of captured images to which file numbers are assigned according to a specific rule; receiving an instruction to insert a divider image between two captured images adjacent in order of file numbers among the plurality of captured images; and generating, in a case where the instruction is received, a divider image to which a file number between file numbers of the two captured images among the file numbers is assigned, if the file numbers of the two captured images are not consecutive.

Further features of the present invention will become apparent from the following description of exemplary embodiments with reference to the attached drawings.

### BRIEF DESCRIPTION OF THE DRAWINGS

FIGS. 1A and 1B are external views of a digital camera according to a first embodiment;

FIG. 2 is a block diagram of the digital camera according to the first embodiment;

FIGS. 3A and 3B are diagrams illustrating insertion of divider images according to the first embodiment;

FIGS. 4A and 4B are diagrams illustrating assignment of file numbers according to the first embodiment;

FIGS. 5A to 5E are diagrams illustrating a setting screen according to the first embodiment;

FIG. 6 is a flowchart illustrating processing during shooting of an image according to the first embodiment; and

FIG. 7 is a flowchart illustrating processing during playback of an image according to the first embodiment.

### DESCRIPTION OF THE EMBODIMENTS

In the following, an embodiment of the present invention is described in detail with reference to the accompanying drawings. Note that the embodiment described below illustrates examples as a method for embodying the present invention, and if needed, may be modified or changed in accordance with various conditions or the configuration of the apparatus to which the present invention is applied. The embodiment can be combined as appropriate.

### First Embodiment

Hereinafter, a digital camera 100 according to the first embodiment is described with reference to the drawings.

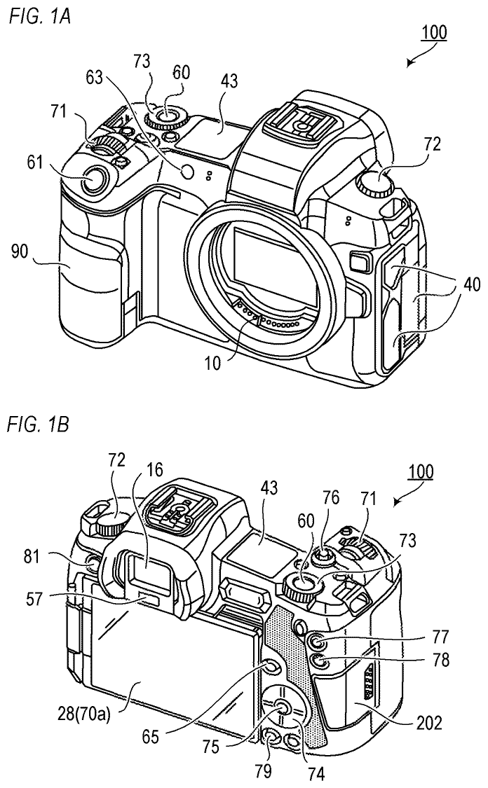

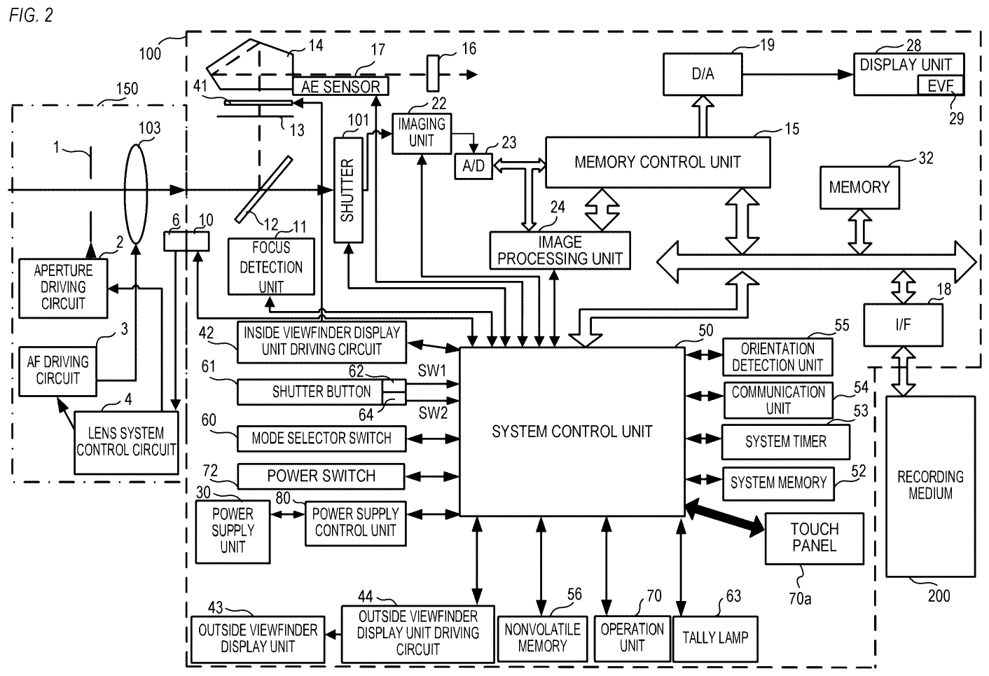

FIGS. 1A and 1B provide external views of the digital camera 100 as an example of an electronic device according to the first embodiment. FIG. 1A is a front perspective view of the digital camera 100. FIG. 1B is a rear perspective view of the digital camera 100. FIG. 2 is a block diagram of the digital camera 100.

A display unit 28 is a display unit provided on the rear surface of the digital camera 100. The display unit 28 displays images and various types of information. The display unit 28 may be a vari-angle display unit or a tilt display unit. The orientation of the display unit 28 may be changeable in various directions. A touch panel 70a can detect a touch operation on a display surface (operation surface) of the display unit 28. An outside viewfinder display unit 43 is a display unit provided on the upper surface of the camera. Various setting values (a shutter speed, an aperture, and the like) of the digital camera 100 are displayed on the outside viewfinder display unit 43.

A shutter button 61 is an operation member for performing a shooting (capturing) instruction. A mode selector switch 60 is an operation member for switching among various modes. A terminal cover 40 is a cover that protects a connector (not illustrated) that connects a “connection cable for ensuring connection to an external device” and the “digital camera 100”.

A main electronic dial 71 is a rotary operation member included in an operation unit 70. A user can change a setting value such as the shutter speed or the aperture by turning the main electronic dial 71.

A power switch 72 is an operation member that switches between ON and OFF of the power of the digital camera 100. A sub-electronic dial 73 is a rotary operation member included in the operation unit 70. The sub-electronic dial 73 can perform shifting of a selection frame or scrolling of images by being operated. A cross key 74 is a cross-key operation member (four-direction key) included in the operation unit 70. The cross key 74 includes push buttons that can respectively push upper, lower, left, and right portions (push buttons that can be pushed and are respectively disposed in four directions). Processing corresponding to the pressed portion of the cross key 74 is executed. A SET button 75 is a push button included in the operation unit 70. The SET button 75 is mainly used to determine a selection item. A moving image button 76 is used for an instruction to start or stop moving image shooting (recording).

An AE lock button 77 is included in the operation unit 70. The AE lock button 77 can fix an exposed state by being pressed in a shooting standby state. An enlargement button 78 is included in the operation unit 70. The enlargement button 78 is an operation button for performing switching between ON and OFF of an enlargement mode in live view display of a shooting mode. By turning on the enlargement mode and then operating the main electronic dial 71, enlargement/reduction of the live view image can be performed. In a playback mode, the enlargement button 78 functions as an enlargement button for “enlarging a playback image and increasing an enlargement ratio”.

A playback button 79 is included in the operation unit 70. The playback button 79 is an operation member that switches between the shooting mode and the playback mode. When the playback button 79 is pressed during the shooting mode, the mode transitions to the playback mode, and the latest one of images recorded in a recording medium 200 is displayed on the display unit 28. A menu button 81 is included in the operation unit 70. When the menu button 81 is pressed, menu screens on which various settings are performed are displayed on the display unit 28. A user can intuitively perform various settings using the “the cross key 74, the SET button 75, or the multi-controller (hereinafter referred to as “MC”) 65″ while viewing the menu screen displayed on the display unit 28.

The MC 65 can receive direction instructions in eight directions and a pushing operation of the central portion. A communication terminal 10 is a communication terminal that causes the digital camera 100 to perform communication with a lens unit 150 (attachable and detachable) described below. An eyepiece portion 16 is an eyepiece portion of an eyepiece viewfinder (looking-through type viewfinder). A user can visually recognize an image displayed on an internal electric view finder (EVF) 29 through the eyepiece portion 16. An eyepiece detection unit 57 is an eyepiece detection sensor that detects whether an eye of a user approaches the eyepiece portion 16. A lid 202 is a lid of a slot that stores the recording medium 200.

A grip portion 90 is a holding portion having a shape easy for a user to grip with the right hand when the user holds the digital camera 100. The shutter button 61 and the main electronic dial 71 are disposed at “positions where a user can operate the shutter button 61 and the main electronic dial 71 with the index finger of the right hand in a state in which the digital camera is held by gripping the grip portion 90 with the little finger, the ring finger, and the middle finger of the right hand”. Also, in the same state, the sub-electronic dial 73 is disposed at a position where a user can operate the sub-electronic dial 73 with the thumb finger of the right hand. A tally lamp (light emitting element) 63 performs operations such as turning on, turning off, and blinking in order to perform notification to a photographer/videographer.

FIG. 2 is a block diagram illustrating a configuration example of the digital camera 100 according to the first embodiment. The lens unit 150 is a lens unit equipped with an interchangeable imaging lens. A lens 103 is usually configured with a plurality of lenses, but FIG. 2 illustrates only one lens in a simplified manner.

A communication terminal 6 is a communication terminal that enables the lens unit 150 to perform communication with the digital camera 100. The lens unit 150 communicates with a system control unit 50 via the communication terminals 6 and 10. A lens system control circuit 4 performs control of an aperture 1 via an aperture driving circuit 2. Thereafter, the lens system control circuit 4 adjusts the focus by displacing the lens 103 via an AF driving circuit 3.

A shutter 101 is a focal plane shutter. The shutter 101 can freely control the exposure time of an imaging unit 22 by being controlled by the system control unit 50.

The imaging unit 22 is an imager including an element (a CCD or a CMOS element) that converts an optical image into an electrical signal. An A/D converter 23 converts an analog signal output from the imaging unit 22 into a digital signal.

An image processing unit 24 performs image processing (predetermined pixel interpolation, resizing processing such as reduction, and color conversion processing) on “data from the A/D converter 23 or data from a memory control unit 15”. The image processing unit 24 performs predetermined arithmetic processing using the captured image data. The system control unit 50 performs exposure control and distance measurement control on the basis of the result of arithmetic processing obtained by the image processing unit 24. As a result, through-the-lens (TTL) autofocus (AF) processing, auto exposure (AE) processing, and flash pre-flash (EF) processing are performed. The image processing unit 24 further performs predetermined arithmetic processing using the captured image data. The image processing unit 24 then performs TTL auto white balance (AWB) processing on the basis of the obtained result of arithmetic processing.

The memory control unit 15 controls transmission and reception of data among specific configurations (the A/D converter 23, the image processing unit 24, and a memory 32). Output data from the A/D converter 23 is written into the memory 32 via the image processing unit 24, the memory control unit 15, and a D/A converter 19. Alternatively, the output data from the A/D converter 23 is written into the memory 32 via the memory control unit 15 and the D/A converter 19.

The memory 32 stores the image data that is obtained by the imaging unit 22 and is converted into digital data by the A/D converter 23. The memory 32 also stores image data for displaying an image on the display unit 28 and the EVF 29. The memory 32 has a storage capacity that is large enough to store a predetermined number of still images and moving images and sound in a predetermined time.

The memory 32 also serves as a memory for image display (video memory). The image data for display, which is written into the memory 32, is displayed by the display unit 28 or the EVF 29. The display unit 28 and the EVF 29 perform display in accordance with a signal from the memory control unit 15 on a display such as an LCD or an organic EL. The data A/D-converted by the A/D converter 23 and accumulated in the memory 32 is sequentially transferred to the display unit 28 or the EVF 29. The display unit 28 or the EVF 29 can perform live view display (LV display) by performing display corresponding to the transferred data. Hereinafter, an image displayed in live view is referred to as a “live view image (LV image)”.

A nonvolatile memory 56 is an electrically erasable and recordable memory. For example, a flash-ROM is used as the nonvolatile memory 56. In the nonvolatile memory 56, constants, programs, and the like for the operation of the system control unit 50 are stored. The program as used herein is a computer program for executing various flowcharts described below.

The system control unit 50 controls the overall digital camera 100. The system control unit 50 is a control unit including at least one processor or circuit. The system control unit 50 implements each piece of processing of the first embodiment by executing programs recorded in the nonvolatile memory 56. For example, a RAM is used as a system memory 52. In the system memory 52, constants, variables, and programs read from the nonvolatile memory 56 for the operation of the system control unit 50 are loaded. The system control unit 50 also performs display control by controlling the memory 32, the display unit 28, or the like.

A system timer 53 is a timer unit that counts time used for various controls and time of a built-in clock.

The mode selector switch 60, a first shutter switch 62, a second shutter switch 64, and the operation unit 70 are operation members (reception units) for inputting various operation instructions to the system control unit 50 (i.e., for receiving operation instructions). The mode selector switch 60 switches an operation mode of the system control unit 50 to any of a still image shooting mode, a moving image shooting mode, and the like. Examples of the modes of the still image shooting mode include an auto shooting mode, an auto scene-determination mode, a manual mode, an aperture-priority mode (Av mode), a shutter-speed priority mode (Tv mode), and a program AE mode (P mode). Other examples of the modes of the still image shooting mode includes a custom mode and various scene modes in which shooting settings are performed for each shooting scene. A user can directly switch the still image shooting mode to any one of these modes by using the mode selector switch 60. Alternatively, a user may display a list screen of a shooting mode using the mode selector switch 60 and then switch the still image shooting mode by selecting any one of the plurality of displayed modes and using another operation member. Similarly, the moving image shooting mode may include a plurality of modes.

When the first shutter switch 62 is turned on in the middle of an operation of the shutter button 61 provided in the digital camera 100 in response to so-called half-press (shooting preparation instruction), the first shutter switch 62 generates a first shutter switch signal SW1. Due to the generation of the first shutter switch signal SW1, a shooting preparation operation such as autofocus (AF) processing, auto exposure (AE) processing, auto white balance (AWB) processing, or flash pre-flash (EF) processing is started.

When the second shutter switch 64 is turned on at completion of the operation of the shutter button 61 in response to so-called full-press (shooting instruction), the second shutter switch 64 generates a second shutter switch signal SW2. Due to the generation of the second shutter switch signal SW2, the system control unit 50 starts operations of a series of shooting processing (processing from reading a signal from the imaging unit 22 to writing a captured image as an image file into the recording medium 200).

The operation unit 70 includes various operation members as an input unit that receives an operation from a user. The operation unit 70 includes the shutter button 61, the multi-controller 65, the touch panel 70a, the main electronic dial 71, the power switch 72, and the sub-electronic dial 73. The operation unit 70 further includes the cross key 74, the SET button 75, the moving image button 76, the AE lock button 77, the enlargement button 78, the playback button 79, and the menu button 81.

A power supply control unit 80 includes a battery detection circuit, a DC-DC converter, a switch circuit (a circuit that switches a block to be energized). The power supply control unit 80 performs detection of whether a battery is mounted, the type of battery, and the battery level. In addition, the power supply control unit 80 controls the DC-DC converter on the basis of a result of the detection and an instruction from the system control unit 50. With this control, the power supply control unit 80 supplies a required voltage to units/portions including the recording medium 200 for a necessary period of time. A power supply unit 30 includes a primary battery (such as alkaline or lithium batteries), a secondary battery (such as NiCd, NiMH, or Li batteries), or an AC adapter.

A recording medium I/F 18 is an interface connected to the recording medium 200 (such as a memory card or a hard disk). The recording medium 200 is a memory card or the like for recording a shot (captured) image. The recording medium 200 includes a semiconductor memory or a magnetic disk.

A communication unit 54 is connected to an external apparatus or the like wirelessly or via a wired cable. The communication unit 54 performs transmission/reception of image signals and audio signals. The communication unit 54 can also be connected to a wireless local area network (LAN) or the Internet. In addition, the communication unit 54 can communicate with an external device also by using Bluetooth (registered trademark) or Bluetooth Low Energy. The communication unit 54 can transmit an image (including a live view image) captured by the imaging unit 22 and an image recorded in the recording medium 200. Furthermore, the communication unit 54 can receive images and other various types of information from an external device.

An orientation detection unit 55 detects the orientation of the digital camera 100 with respect to the direction of gravity. Based on the orientation detected by the orientation detection unit 55, whether an image shot by the imaging unit 22 is an image shot with the digital camera 100 held in a horizontal position or an image shot with the digital camera 100 held in a vertical position can be determined. The system control unit 50 can add direction information corresponding to the orientation detected by the orientation detection unit 55 to an image file of the image captured by the imaging unit 22. In addition, the system control unit 50 can record an image after rotating the image in accordance with the direction information. An acceleration sensor, a gyro sensor, or the like can be used as the orientation detection unit 55. The orientation detection unit 55 can also detect the movement of the digital camera 100 (e.g., whether the digital camera 100 is panned, tilted, lifted, or stationary) by using an acceleration sensor or a gyro sensor.

The eyepiece detection unit 57 is an eyepiece detection sensor. The eyepiece detection unit 57 detects approach (eye approach) and separation (eye separation) of an eye (object) to and from the eyepiece portion 16 of the viewfinder. The system control unit 50 switches between display (display state) and non-display (non-display state) of each of the display unit 28 and the EVF 29 in accordance with the state detected by the eyepiece detection unit 57. More specifically, in a case where at least the digital camera 100 is in the shooting standby state, and a switching setting for a display destination of the live view image captured by the imaging unit 22 is set to automatic switching setting, the display unit 28 is selected as the display destination and the EVF 29 is hidden while an eye is not approached. The EVF 29 is selected as the display destination and the display unit 28 is hidden while an eye is approached.

For example, an infrared proximity sensor can be used as the eyepiece detection unit 57. The eyepiece detection unit 57 can detect any object approaching the eyepiece portion 16 of the viewfinder incorporating the EVF 29. When an object approaches, infrared light emitted from a light-emitting portion (not illustrated) of the eyepiece detection unit 57 is reflected and is received by a light-receiving portion (not illustrated) of an infrared proximity sensor. The eyepiece detection unit 57 can also determine how close the object is to the eyepiece portion 16 in distance (eye approach distance) by using the amount of the received infrared light. In this way, the eyepiece detection unit 57 performs eye approach detection for detecting an approach distance of the object to the eyepiece portion 16.

The touch panel 70a and the display unit 28 can be integrally configured. For example, the touch panel 70a is configured to have such a transmittance of light that display on the display unit 28 is not hindered. The touch panel 70a is attached to an upper layer of the display surface of the display unit 28. Then, input coordinates on the touch panel 70a are associated with display coordinates on the display screen of the display unit 28. In this way, a graphical user interface (GUI) can be provided as if a user can directly operate the screen displayed on the display unit 28.

The system control unit 50 can detect the following operations on the touch panel 70a or the following states of the touch panel 70a.
A new touch of a finger or a pen that has not touched the touch panel 70a to the touch panel 70a, that is, the start of a touch (hereinafter, referred to as touch-down);
A state in which a finger or a pen is touching the touch panel 70a (hereinafter, referred to as touch-on);
An operation in which a finger or a pen is moving while touching the touch panel 70a (hereinafter, referred to as touch-move);
A release of a finger or a pen that has been touching the touch panel 70a, that is, the end of a touch (hereinafter, referred to as touch-up);
A state in which nothing touches the touch panel 70a (hereinafter, referred to as touch-off); and
Touch-down on the touch panel 70a and touch-up within a predetermined time without performing touch-move (hereinafter, referred to as tap).

When the touch-down is detected, the touch-on is detected at the same time. After the touch-down, the touch-on is continuously detected normally unless the touch-up is detected. The state in which the touch-move is detected is also a state in which the touch-on is detected. Even when the touch-on is detected, the touch-move is not detected unless the touch position is moved. After the touch-up of all the fingers and the pens that have touched the touch panel 70a is detected, the state transitions to the touch-off.

The system control unit 50 is notified of these operations and states and position coordinates of the touched position at which a finger or a pen is in contact with the touch panel 70a via an internal bus. The system control unit 50 determines what kind of operation (touch operation) has been performed on the touch panel 70a on the basis of the information of which the system control unit 50 is notified.

With regard to the touch-move, a movement direction of a finger or a pen moving on the touch panel 70a can be determined for each vertical component and for each horizontal component on the touch panel 70a on the basis of a change of the position coordinates. When the touch-move for a predetermined distance or more is detected, it is determined that a sliding operation has been performed. An operation of quickly moving a finger by a certain distance while touching a touch panel with the finger, and then releasing the finger is called a “flick”. In other words, the flick is an operation of quickly tracing the touch panel 70a so as to flick the touch panel 70a with a finger. When the touch-move at a predetermined speed or higher for a predetermined distance or more is detected and then the touch-up is detected, it can be determined that a flick has been performed (it can be determined that a flick has been performed subsequently to a sliding operation).

Further, a touch operation in which a plurality of locations (e.g., two locations) are touched at the same time and touch positions are brought close to each other is referred to as a “pinch-in”, and a touch operation in which the touch positions are moved away from each other is referred to as a “pinch-out”. The pinch-out and the pinch-in are collectively referred to as a pinch operation (or simply referred to as pinch).

As the touch panel 70a, any of various types of touch panels can be used, including resistive, capacitive, surface acoustic-wave, infrared, electromagnetic-induction, image-recognition, and optical-sensor touch panels. There are a “type in which a touch is detected based on contact with the touch panel” and a “type in which a touch is detected based on approach of a finger or a pen to the touch panel”, but any of these types may be used.

A user can set the “method of designating the position of the position indicator in accordance with the touch-move operation” to any of absolute position designation or relative position designation. For example, in the case where the position indicator is an AF flame and the absolute position designation is set, the AF position associated with the touched position (position whose coordinates are input) is set in response to the touch panel 70a being touched. That is, the position coordinates at which touch operation is performed is associated with the position coordinates of the display unit 28. On the other hand, in the relative position designation, the position coordinates at which touch operation is performed is not associated with the position coordinates of the display unit 28. In the relative position designation, regardless of the touch-down position with respect to the touch panel 70a, the touch position is moved from the currently set AF position by a distance corresponding to the movement amount of touch-move in the movement direction of the touch-move.

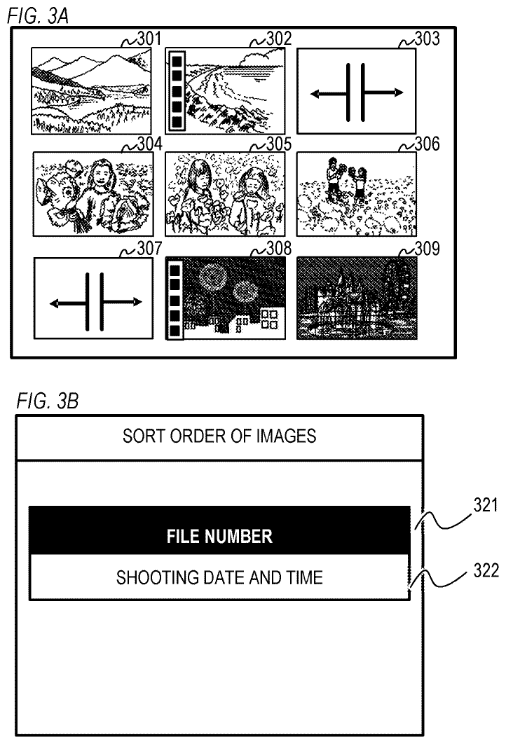

FIGS. 3A and 3B are diagrams illustrating insertion of divider images.

FIG. 3A illustrates that a plurality of images 301 to 309 are displayed on the display unit 28 of the digital camera 100. In FIG. 3A, the images 301, 304, 305, 306, and 309 are still images among shot images. The images 302 and 308 are moving images among shot images. The images 303 and 307 are divider images different from shot images.

The divider image is an image that can be grasped as an image different from “shot still images and moving images”. The divider image is a monochrome image, an image of a simple mark, an image of characters indicating that it is a divider image, or the like. In FIG. 3A, the images 301 to 309 are sorted in order of file number.

FIG. 3B is a screen on which a user selects (sets) the sort order (display order) of images. An option 321 is an option of sorting images in order of file number when selected. An option 322 is an option of sorting images in order of shooting date and time. In addition to the options 321 and 322, there may be an option of sorting in ascending order or descending order, or there may be an option of sorting in order of file size.

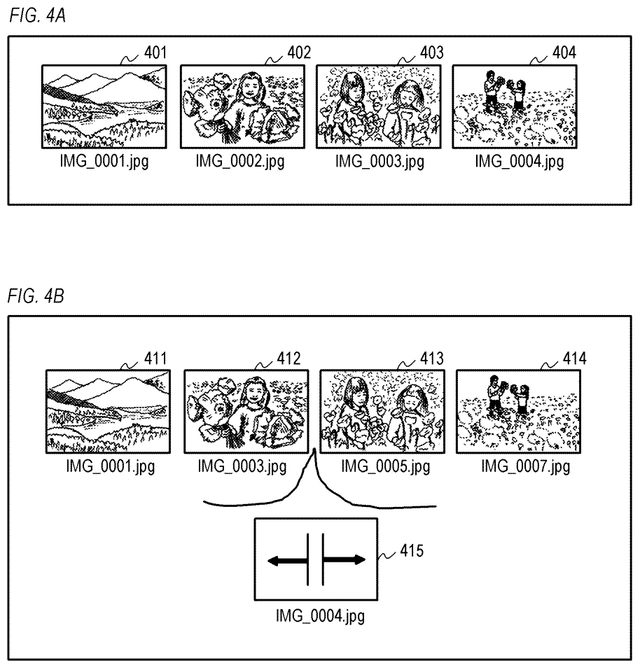

FIGS. 4A and 4B are diagrams illustrating assignment of file numbers.

FIG. 4A is a diagram illustrating that file numbers of the images are consecutive and there is no available file number between the images. File numbers “IMG_0001.jpg” to “IMG_0004.jpg” are consecutively assigned to shot images 401 to 404.

FIG. 4B is a diagram illustrating that file numbers of the images are not consecutive and there is an available file number between the images. A file number “IMG_0001.jpg” is assigned to a shot image 411. A file number “IMG_0003.jpg” is assigned to a shot image 412. A file number “IMG_0005.jpg” is assigned to a shot image 413. A file number “IMG_0007.jpg” is assigned to a shot image 414. Accordingly, file numbers are not consecutive between adjacent shot images. On the other hand, a divider image 415 is a divider image to which a file number “IMG_0004.jpg” is assigned.

In FIG. 4A, the file number of the shot image 402 and the file number of the shot image 403 are consecutive. On the other hand, in FIG. 4B, there is only one available file number between the file number of the shot image 412 and the file number of the shot image 413. Therefore, if a file number between the file number of the shot image 412 and the file number of the shot image 413 is assigned to the divider image 415, the divider image 415 can be inserted between the shot image 412 and the shot image 413.

Generally, as illustrated in FIG. 4A, file numbers of shot images are consecutive. In such a case, however, a divider image cannot be inserted between shot images. On the other hand, as illustrated in FIG. 4B, when file numbers of shot images are not consecutive, a divider image can be inserted.

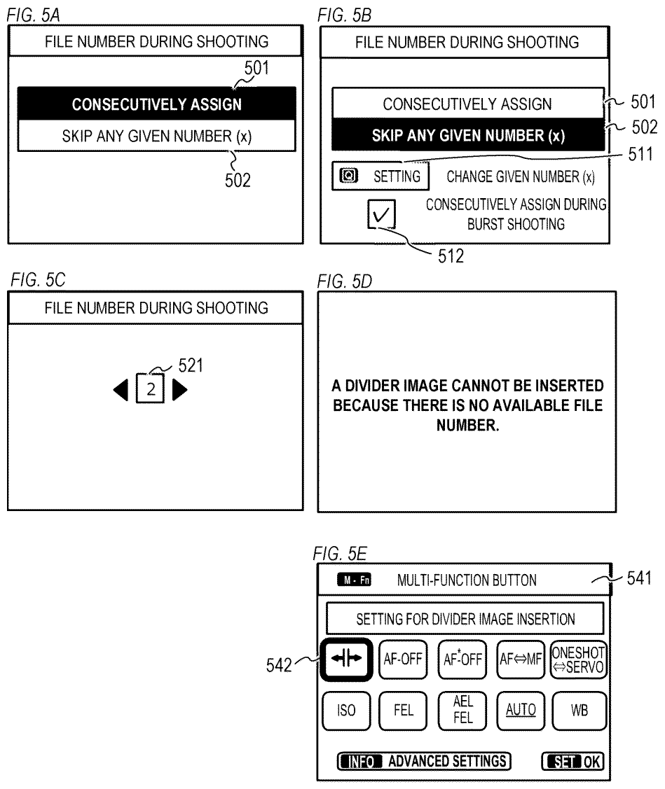

FIGS. 5A to 5E are diagrams illustrating setting screens related to assignment of file numbers.

FIGS. 5A and 5B are screens for setting an assignment method (assignment rule) of a file number during shooting.

An option 501 is an option indicating that file numbers are consecutively assigned to shot images. An option 502 is an option indicating that file numbers are assigned to shot images at intervals in such a manner that the file numbers are not consecutive. FIG. 5A illustrates a state in which the option 501 is selected. FIG. 5B illustrates a state in which the option 502 is selected. When the option 502 is selected, a button 511 and a check box 512 are displayed. When the button 511 is selected, a screen for setting a number defining how many available numbers are included in an interval of file numbers is displayed as illustrated in FIG. 5C. When the check box 512 is checked, “setting in which file numbers are consecutively assigned to shot images during burst shooting” is performed even when the option 502 is selected.

FIG. 5C illustrates a screen for setting an interval between file numbers in a case where file numbers are assigned at intervals in such a manner that the file numbers are not consecutive. By using a text box 521, a user can freely set the interval of file numbers between shot images (two shot images whose shooting times are adjacent to each other). Specifically, file numbers assigned to two shot images whose shooting times are adjacent to each other are different by the number equal to “the number set in the text box 521”+1. Any number of 1 or more can be set in the text box 521.

As described above, a user can select a method (rule) of assigning file numbers to shot images by referring to the screen illustrated in FIGS. 5A and 5B. On the other hand, regardless of the above setting by the user, in a first case, the digital camera 100 may determine to assign consecutive file numbers to shot images. In a second case different from the first case, the digital camera 100 may determine to assign file numbers to shot images at intervals each corresponding to a specific number in such a manner that the file numbers are not consecutive.

Examples of the second case include a case where a lens mounted on the digital camera 100 is changed, a case where a predetermined time has elapsed since previous shooting, a case where a date is changed, a case where a setting related to image quality is changed, and a case where power is switched between OFF and ON. The second case may be a case where flash shooting is performed. The second case may be a case where the orientation of the digital camera 100 has changed by an angle more than a predetermined angle, or a case where the brightness of the surrounding environment of the digital camera 100 has changed by a value more than a predetermined value. The second case may be a case where the shooting position (latitude or longitude) of the digital camera 100 has changed by a distance more than a predetermined distance.

Further, the first case may be a case where a function other than the function of inserting a divider image is assigned to a multi-function button, and the second case may be a case where the function of inserting a divider image is assigned to the multi-function button. With this configuration, only when the user plans to insert a divider image by pressing the multi-function button, the digital camera 100 can assign file numbers to shot images at intervals in such a manner that the file numbers are not consecutive. Therefore, a divider image can be inserted when a user desires, and the convenience of a user is improved.

The first case may be a case where the display of shot images in order of shooting date and time is selected (case where the option 322 is selected), and the second case may be a case where the display of shot images in order of file number is selected (case where the option 321 is selected). With this configuration, only when a user plans to display shot images in order of file number, the digital camera 100 can assign file numbers to shot images at intervals in such a manner that the file numbers are not consecutive. Therefore, a divider image can be inserted when a user desires, and the convenience of a user is improved.

FIG. 5D illustrates an example of a user notification in a case where a divider image cannot be inserted because file numbers of shot images are consecutive. The first embodiment presents an example of notifying a user by displaying a character string (wording) representing that insertion of a divider image has failed. A user may be notified that insertion of a divider image has failed, by using sound, vibration, display (lighting) of the tally lamp 63, or the like.

FIG. 5E illustrates a setting screen for assigning a function to an operation member of the operation unit 70. A screen name 541 represents that a function is assigned to the multi-function button that is one of the operation members. A cursor 542 is a thick frame representing that a function corresponding to the icon indicated by the cursor 542 is assigned to the multi-function button. In FIG. 5E, the cursor 542 represents that a function of divider image insertion (function of performing insertion of a divider image) is assigned to the multi-function button. The screen name 541 may represent not only the multi-function button but also any operation member to which any of the plurality of functions can be set. In addition, the function of divider image insertion may be assigned to the multi-function button by default, or may be assigned to the multi-function button by an operation of a user.

### Processing During Shooting of Image

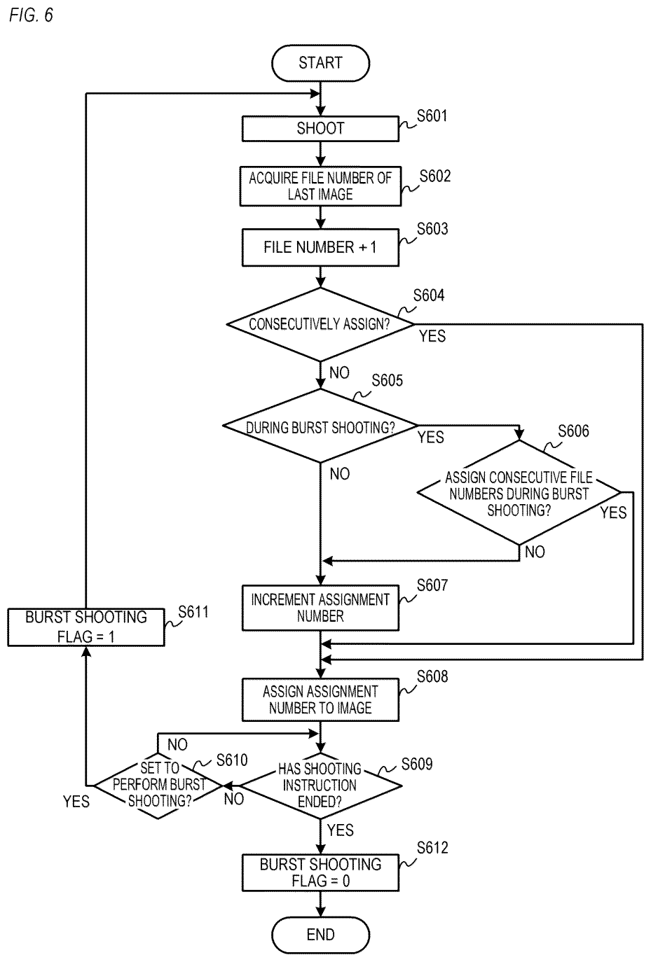

Processing of assigning a file number to a shot image is described with reference to the flowchart of FIG. 6. This processing is implemented by loading a program recorded in the nonvolatile memory 56 into the system memory 52 and executing the program by the system control unit 50. When a shooting instruction is detected in response to the shutter button 61 being pressed, the processing of this flowchart starts.

In step S601, the system control unit 50 execute shooting. As a result of shooting, the system control unit 50 acquires one shot image.

In step S602, the system control unit 50 acquires the file number of the last image (having the largest file number) stored in the recording medium 200.

In step S603, the system control unit 50 holds the number obtained by incrementing the file number acquired in step S602 by one as an assignment number.

In step S604, the system control unit 50 determines which one of “the option 501 of consecutively assigning file numbers” and “the option 502 of assigning file numbers at intervals in such a manner that file numbers are not consecutive” is selected on the screen illustrated in FIG. 5A. If it is determined that the option 501 is selected, the process proceeds to step S608. If it is determined that the option 502 is selected, the process proceeds to step S605.

In step S605, the system control unit 50 refers to the burst shooting flag stored in the system memory 52 and determines whether burst shooting (continuous shooting) is being performed (i.e., the burst shooting flag indicates 1). If it is determined that burst shooting is being performed, the process proceeds to step S606. If it is determined that burst shooting is not being performed, the process proceeds to step S607.

In step S606, the system control unit 50 determines whether “the check box 512 for assigning file numbers during burst shooting” on the screen 510 is checked. If it is determined that the check box 512 is checked, the process proceeds to step S608. If it is determined that the check box 512 is not checked, the process proceeds to step S607.

In step S607, the system control unit 50 increments the assignment number by the number set in the text box 521 illustrated in FIG. 5C.

In step S608, the system control unit 50 assigns an assignment number to the shot image acquired in step S601 as a file number. Thereafter, the system control unit 50 records, on the recording medium 200, the shot image to which the file number is assigned.

In step S609, the system control unit 50 determines whether the pressing of the shutter button 61 has ended and the shooting instruction has ended. If it is determined that shooting instruction has ended, the process proceeds to step S612. If it is determined that shooting instruction has not ended, the process proceeds to step S610.

In step S610, the system control unit 50 determines whether the digital camera 100 is set to perform burst shooting. If it is determined that the digital camera 100 is set to perform burst shooting, the process proceeds to step S611. If it is determined that the digital camera 100 is not set to perform burst shooting, the process proceeds to step S609.

In step S611, the system control unit 50 updates the burst shooting flag stored in the system memory 52 such that the burst shooting flag indicates 1.

In step S612, the system control unit 50 updates the burst shooting flag stored in the system memory 52 such that the burst shooting flag indicates 0.

By the processing of the flowchart of FIG. 6, a user can set whether “to make file numbers consecutive” or “to make file numbers available by any number” during shooting.

### Processing During Playback of Image

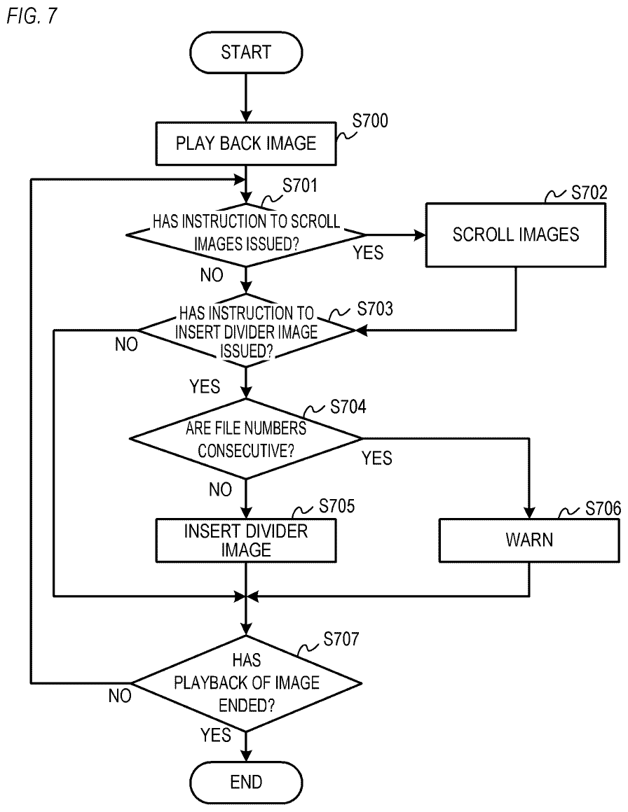

With reference to the flowchart of FIG. 7, the processing of the flowchart of inserting a divider image during playback of an image is described. This processing is implemented by loading a program recorded in the nonvolatile memory 56 into the system memory 52 and executing the program by the system control unit 50. The processing of this flowchart starts when it is detected that an instruction to play back an image recorded in the recording medium 200 has been issued.

In step S700, the system control unit 50 displays (plays back), on the display unit 28, one or a plurality of images recorded in the recording medium 200.

In step S701, the system control unit 50 determines whether an instruction to scroll images has been issued. A user can perform an instruction to scroll images by operating the operation unit 70. If it is determined that an instruction to scroll images has been issued, the process proceeds to step S702. If it is determined that an instruction to scroll images has not been issued, the process proceeds to step S703.

In step S702, the system control unit 50 displays, on the display unit 28, one or a plurality of images in accordance with the instruction to scroll images. That is, the system control unit 50 replaces the image to be displayed on the display unit 28 in response to the instruction to scroll images.

In step S703, the system control unit 50 determines whether an instruction to insert a divider image has been issued. A user can issue an instruction to insert a divider image by operating the operation unit 70. In the first embodiment, the instruction to insert a divider image is an instruction that clearly specifies the insertion position of the divider image. The instruction to insert a divider image is an instruction to insert a divider image between two shot images adjacent to each other in order of file number based on the insertion position of the divider image. If it is determined that an instruction to insert a divider image has been issued (if the operation unit 70 has received an instruction to insert a divider image), the process proceeds to step S704. If it is determined that an instruction to insert a divider image has not been issued, the process proceeds to step S707.

In step S704, the system control unit 50 determines whether file numbers of the immediately prior image and the immediately subsequent image of the “insertion position clearly specified by the instruction to insert a divider image” are consecutive. In other words, the system control unit 50 determines whether file numbers of two images adjacent to each other in order of file number on the basis of the “insertion position clearly specified by the instruction to insert a divider image” are consecutive. If it is determined that file numbers of the two images are consecutive, a divider image is not generated, and the process proceeds to step S706. If it is determined that file numbers of the two images are not consecutive, the process proceeds to step S705.

In step S705, the system control unit 50 generates a divider image. The system control unit 50 assigns, as a file number, a number obtained by incrementing the “file number of the image immediately prior to the position into which insertion is performed by an instruction” by one or any given number, to the divider image. The given number is a value that does not exceed the difference between file numbers of the images immediately prior/subsequent to the position into which insertion is performed by an instruction. Therefore, the system control unit 50 may assign any given file number to the divider image as long as the given file number is between file numbers of the images immediately prior/subsequent to the “insertion position clearly specified by the instruction to insert a divider image”. Then, the system control unit 50 stores the divider image in the recording medium 200.

In step S706, the system control unit 50 notifies a warning indicating that a divider image cannot be inserted (generated). In the warning, for example, the guidance illustrated in FIG. 5D is displayed.

In step S707, the system control unit 50 determines whether an instruction to play back the image recorded in the recording medium 200. If it is determined that the playback instruction has ended, the processing of this flowchart ends. If it is determined that playback instruction has not ended, the process proceeds to step S701.

According to the processing of the flowcharts of FIGS. 6 and 7, a user can easily insert a divider image between a plurality of shot images sorted in order of file number. Furthermore, when a divider image cannot be inserted between a plurality of shot images, a user can know such a situation by notification.

According to the first embodiment, when insertion of a divider image during playback of an image after shooting is desired, a divider image can be inserted between a plurality of shot images. Since a file number is also assigned to the divider image according to the same file number rule as that of shot images, the divider image is inserted at a predetermined position even when the images are checked after being transferred to another terminal such as a PC. Therefore, it is possible to provide an electronic device (imaging apparatus or display apparatus) that can easily recognize the division between shot images.

While the present invention has been described in detail thus far based on its preferred embodiment, the present invention is not limited to the specific embodiment, and various forms without departing from the gist of the invention are also included in the present invention. Some of the above-described embodiment may be appropriately combined.

In addition, in the above description, “if A is B or more, the process proceeds to step S1, and if A is smaller (lower) than B, the process proceeds to step S2” may be read as “if A is larger (higher) than B, the process proceeds to step S1, and if A is B or less, the process proceeds to step S2”. Conversely, “if A is larger (higher) than B, the process proceeds to step S1, and if A is B or less, the process proceeds to step S2” may be read as “if A is B or more, the process proceeds to step S1, and if A is smaller (lower) than B, the process proceeds to step S2”. Accordingly, unless a contradiction arises, “A or more” may be read as “larger (higher; longer; more) than A”, and “A or less” may be read as “smaller (lower; shorter; less) than A”. Moreover, “larger (higher; longer; more) than A” may be read as “A or more”, and “smaller (lower; shorter; less) than A” may be read as “A or less”.

Note that the above-described various types of control may be processing that is carried out by one piece of hardware (e.g., processor or circuit), or otherwise. Processing may be shared among a plurality of pieces of hardware (e.g., a plurality of processors, a plurality of circuits, or a combination of one or more processors and one or more circuits), thereby carrying out the control of the entire device.

Also, the above processor is a processor in the broad sense, and includes general-purpose processors and dedicated processors. Examples of general-purpose processors include a central processing unit (CPU), a micro processing unit (MPU), a digital signal processor (DSP), and so forth. Examples of dedicated processors include a graphics processing unit (GPU), an application-specific integrated circuit (ASIC), a programmable logic device (PLD), and so forth. Examples of PLDs include a field-programmable gate array (FPGA), a complex programmable logic device (CPLD), and so forth.

Furthermore, in the above-described embodiment, a case where the present invention is applied to the digital camera is described as an example, but the present invention is not limited to the example, and any electronic device capable of controlling display of a shot image is applicable. Of course, the present invention can also be applied to a smartphone instead of a digital camera.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the present invention, a technique related to insertion of a divider image during playback of an image can be provided.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-038049, filed on Mar. 12, 2024, which is hereby incorporated by reference herein in its entirety.

What is claimed is:

1. An electronic device comprising:
a processor; and
a memory storing a program which, when executed by the processor, causes the electronic device to
execute acquisition processing of acquiring a plurality of captured images to which file numbers are assigned according to a specific rule;
execute reception processing of receiving an instruction to insert a divider image between two captured images adjacent in order of file numbers among the plurality of captured images; and
execute generation processing of generating, in a case where the reception processing receives the instruction, a divider image to which a file number between file numbers of the two captured images among the file numbers is assigned, if the file numbers of the two captured images are not consecutive.

2. The electronic device according to claim 1, wherein
in the generation processing, the divider image is not generated if the instruction has been received in the reception processing and the file numbers of the two captured images are consecutive.

3. The electronic device according to claim 2, wherein
the program, when executed by the processor, further causes the electronic device to execute notification processing of notifying a user that the divider image is not insertable if the instruction has been received in the reception processing and the file numbers of the two captured images are consecutive.

4. The electronic device according to claim 1, further comprising:
an image sensor; and
the program, when executed by the processor, further causes the electronic device to execute assignment processing of assigning, each time the image sensor performs capturing, a file number to one captured image acquired by the capturing,
wherein in the assignment processing,
consecutive file numbers are assigned to captured images in a first case, and
file numbers are assigned to captured images at an interval in a second case, the file numbers being not consecutive.

5. The electronic device according to claim 4, wherein
the program, when executed by the processor, further causes the electronic device to execute setting processing of performing setting related to assignment of a file number by an operation of a user,
wherein the first case is a case where it is set in the setting processing that consecutive file numbers are assigned to captured images, and
the second case is a case where it is set in the setting processing that consecutive file numbers are not assigned to captured images.

6. The electronic device according to claim 5, wherein
in the setting processing, it is capable of setting the interval in a case of a setting in which consecutive file numbers are not assigned to captured images, and
in the assignment processing, file numbers are assigned to captured images at the interval set in the setting processing.

7. The electronic device according to claim 5, wherein
in the setting processing, it is capable of performing setting in which consecutive file numbers are assigned to captured images during burst capturing in a setting in which consecutive file numbers are not assigned to captured images, and
in a case where the setting in which file numbers are made consecutive during the burst capturing is performed, in the assignment processing, consecutive file numbers are assigned to captured images during the burst capturing also in the second case.

8. The electronic device according to claim 4, wherein
the second case is at least any one of
a case where a lens is changed,
a case where a predetermined time has elapsed since a previous capturing,
a case where a date is changed,
a case where a setting related to image quality is changed, or
a case where power is switched between OFF and ON.

9. The electronic device according to claim 4, further comprising
an operation member to which a first function of performing insertion of a divider image is assignable,
wherein the first case is a case where a second function being not the first function is assigned to the operation member, and
the second case is a case where the first function is assigned to the operation member.

10. The electronic device according to claim 4, wherein
the program, when executed by the processor, further causes the electronic device to execute selection processing of selecting a display order of the plurality of captured images in any one of an order of file numbers or an order of capturing dates and times, according to an operation of a user,
wherein the first case is a case where the order of capturing dates and times is selected in the selection processing, and
the second case is a case where the order of file numbers is selected in the selection processing.

11. The electronic device according to claim 1, wherein
the plurality of captured images include a still image and a moving image.

12. A control method of an electronic device, comprising:
acquiring a plurality of captured images to which file numbers are assigned according to a specific rule;
receiving an instruction to insert a divider image between two captured images adjacent in order of file numbers among the plurality of captured images; and
generating, in a case where the instruction is received, a divider image to which a file number between file numbers of the two captured images among the file numbers is assigned, if the file numbers of the two captured images are not consecutive.

13. A non-transitory computer readable medium that stores a program, wherein the program causes a computer to execute a control method of an electronic device, the control method comprising:
acquiring a plurality of captured images to which file numbers are assigned according to a specific rule;
receiving an instruction to insert a divider image between two captured images adjacent in order of file numbers among the plurality of captured images; and
generating, in a case where the instruction is received, a divider image to which a file number between file numbers of the two captured images among the file numbers is assigned, if the file numbers of the two captured images are not consecutive.
